(19) United States
(12) Patent Application Publication
(10) Pub. No.: US 2005/0061804 A1
(43) Pub. Date: Mar. 24, 2005

(54) Induction flux concentrator utilized for forming heat exchangers

(76) Inventor: Norman Golm, Rochester Hills, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/668,023

(22) Filed: Sep. 22, 2003

(51) Int. Cl. H05B 6/10

(52) U.S. Cl. 219/635

(57) ABSTRACT

Induction heating is utilized to braze together a plurality of components for a heat exchanger. The induction heater is provided with flux concentrators that raise the applied temperature at locations on the heat exchanger components which require a higher temperature. In this manner, a relatively small inductor heater can replace the relatively massive furnaces of the prior art.

### BACKGROUND OF THE INVENTION

This invention utilizes induction heating with flux concentrators to focus greater temperature on the areas of a heat exchanger that require more heat for completing the necessary brazing. In particular, the invention relates to such heating of an aluminum heat exchanger.

Heat exchangers such as are utilized in automotive HVAC systems are often formed of aluminum. Heat exchangers have relatively thick headers at each end, with relatively thin side plates extending between the headers. Thinner tubes, and even thinner crossing fins extend between the tubes and the side plates.

Often, a product known as Nocolok™ is coated onto the various members. The Nocolok™ prevents oxidation of the aluminum as the aluminum components are brazed together. The heat exchanger components are often cladded with a silicone-rich aluminum coating at their outer periphery which quickly melts and performs a brazing of the components together. The Nocolok™ coating prevents oxidation of the silicone-rich aluminum coating.

Typically, the heat exchangers are brazed by passing them through a very long furnace. These furnaces cost on the order of a million dollars or more and require large amounts of floor space in a factory.

Brazing can also be accomplished by induction heating. As an example, there is a proposal in the prior art to utilize induction heating for brazing heat exchangers. However, due to the various thicknesses of the components in heat exchangers such as are utilized in automotive HVAC systems, different brazing temperatures are required. Simple induction heating is not capable of providing varying temperatures at the various locations on the heat exchanger.

A feature known as flux concentrators is also known. A flux concentrator allows the application of various degrees of heating at various locations on a component. However, it has not been proposed to utilize flux concentrators in induction brazing for a heat exchanger.

### SUMMARY OF THE INVENTION

In a disclosed embodiment of this invention, a heat exchanger having various components of various thicknesses is brazed within an induction heater, and wherein flux concentrators are utilized to provide varying temperatures across the heat exchanger. Preferably, the flux concentrators are of the sort available from Fluxtrol of Auburn Hills, Mich., and which can be understood by its web page on the internet at www.fluxtrol.com. Also, U.S. Pat. No. 5,418,811 discloses such technology. The use of concentrators allows the application of increased temperature at the thicker parts of the heat exchanger, and lesser temperatures at the thinner parts. In this fashion, induction heating may be easily utilized to effectively braze the heat exchanger components. In preferred embodiments, heat exchanger components are aluminum and are coated with a silicone-rich aluminum cladding.

These and other features of the present invention can be best understood from the following specification and drawings, the following of which is a brief description.

### BRIEF DESCRIPTION OF THE DRAWINGS

FIG. 1 is a schematic view of a heat exchanger such as may be utilized in automotive HVAC systems.

FIG. 2 shows a prior art method for brazing the heat exchanger utilizing a furnace.

FIG. 3 shows the inventive induction heater having flux concentrators associated with the thicker portions of the heat exchanger.

### DETAILED DESCRIPTION OF THE PREFERRED EMBODIMENT

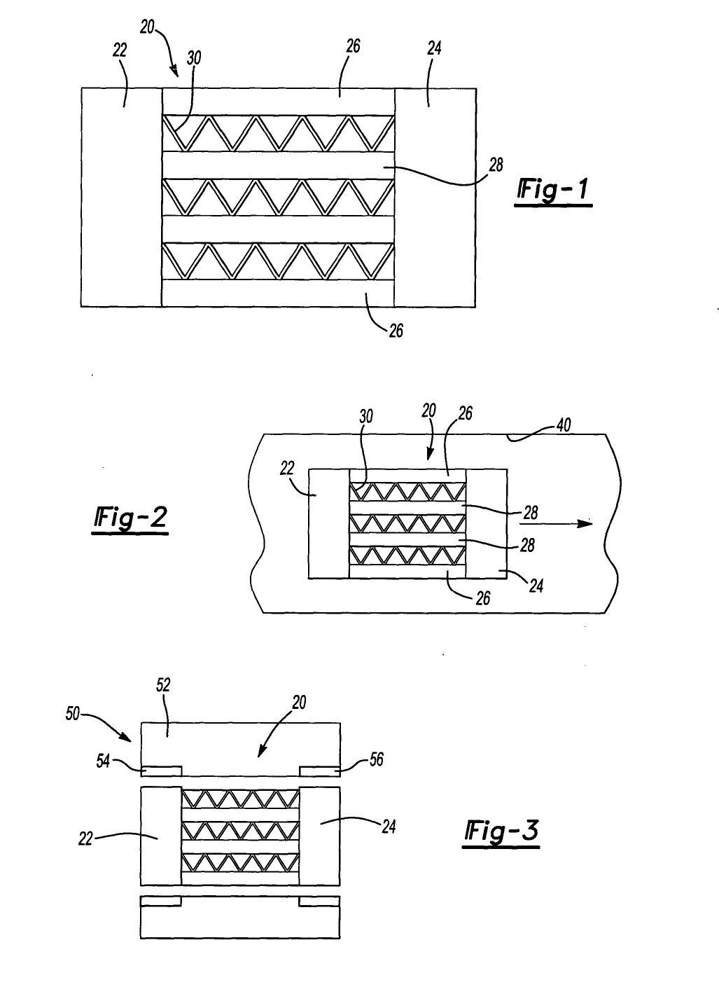

A heat exchanger 20 illustrated in FIG. 1 includes headers 22 and 24 which are preferably formed of aluminum. As can be appreciated, headers 22 and 24 are relatively thick in comparison to the side plates 26 or the tubes 28. Further, fins 30 extend between the plates 26, and the internal tubes 28. Fins 30 are quite thin when compared to the other components. Preferably, the various aluminum components are cladded with a silicone-rich aluminum which will melt when brazed. Often, a Nocolok™ brazing coating is also utilized. Nocolok™ avoids the oxidation of the silicone-rich aluminum coating. Alternatively, a light acid bath can be utilized immediately prior to the brazing such that the Nocolok™ is not required.

As can be appreciated from FIG. 1, the heat exchanger has a number of varying thickness components. Thus, to accomplish adequate and efficient brazing, varying degrees of temperature are required to be applied to the various locations on the heat exchanger.

As shown in FIG. 2, in the prior art, the heat exchanger 20 was passed through a long furnace 40. A fixture would ensure that the adequate heating was applied to the various components 22, 24, 26, 28, 30, etc. during passage through this furnace. However, as explained above, the furnace was necessarily long and quite expensive.

As shown in FIG. 3, the present invention utilizes an induction heater 50 which may be quite small, and not much larger than the size of one heat exchanger, or perhaps a few heat exchangers, such that several heat exchangers can be brazed at one time. The induction heater includes a body 52 having flux concentrators 54 and 56 shown associated with the thicker portions 22 and 24. Now, and as perhaps better explained on the Fluxtrol materials mentioned above, due to the flux concentrators 54 and 56, higher temperatures will be applied at areas 24 and 22 where higher temperatures are required.

Induction heating is caused by the thermal effect of eddy currents induced by magnetic alternating flux. The lines of magnetic flux produced by a coil current must be closed. A sufficient part of the coil amperage is consumed by the flux pushing through the magnetic persistence of the back-path. Thus, high currents must flow in the coil to produce a required flux, and this results in additional losses in the coil. Bare coils magnetic field is distributed over a large areas, and this causes undesired heating of adjacent components in close proximity to the coil. A magnetic flux concentrator reduces the back-path magnetic resistance and concentrates the reduced power in the desired area on the work piece. When properly located, a flux concentrator can provide increased heating in desirable zones and reduced heating in undesirable zones.

Now, with the use of the inventive inductor brazing system 50 having the flux concentrators 54 and 56, a relatively small brazing system is utilized, and the cost and required floor space is greatly reduced over the prior art.

Although a preferred embodiment of this invention has been disclosed, a worker of ordinary skill in this art would recognize that certain modifications would come within the scope of this invention. For that reason, the following claims should be studied to determine the true scope and content of this invention.

1. A method of forming a heat exchanger comprising the steps of:
assembling a plurality of heat exchanger components to be brazed together;
providing an induction heater, said induction heater having at least one flux concentrator associated with an area on said heat exchanger components wherein a higher temperature is desirable; and
inducing magnetic fields in said heat exchanger components to cause said heat exchanger components to braze together, with higher temperatures being provided by said flux concentrator at a selected area which would desirably be raised to a higher temperature.

2. A method as set forth in claim 1, wherein said flux concentrator are of the type available under the trademark Fluxtrol™.

3. A method as set forth in claim 1, wherein said heat exchanger components include relatively large headers, and interconnecting side plates of a thinner size, with said flux concentrators applying greater heat to said headers.

4. A method as set forth in claim 1, wherein said heat exchanger components are formed of aluminum, and have a silicone-rich aluminum coating.

5. A method of forming a heat exchanger comprising the steps of:
assembling a plurality of aluminum heat exchanger components having a silicone-rich aluminum outer coating, said components to be brazed together and including relatively large headers, and interconnecting side plates of a thinner size;
providing an induction heater, said induction heater having flux concentrators associated with at least said headers on said heat exchangers components; and
inducing magnetic fields in said heat exchanger components to cause said heat exchanger components to braze together, with higher temperatures being provided with said flux concentrator at said headers.
